(19) United States
(12) Patent Application Publication
(10) Pub. No.: US 2017/0140538 A1
(43) Pub. Date: May 18, 2017

(54) IMAGE PREPROCESSING METHOD AND ELECTRONIC DEVICE FOR IMAGE REGISTRATION

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Xiubao ZHANG, Beijing (CN)

(21) Appl. No.: 15/243,211

(22) Filed: Aug. 22, 2016

Related U.S. Application Data
(63) Continuation of application No. PCT/CN2016/082536, filed on May 18, 2016.

(30) Foreign Application Priority Data
Nov. 16, 2015 (CN) 201510786425.4

(51) Int. Cl. G06T 7/00; G06T 5/20

(52) U.S. Cl. CPC G06T 7/0024; G06T 5/20

(57) ABSTRACT

Some embodiments of the present disclosure provide an image preprocessing method and an image preprocessing device for image registration. The method includes: selecting a Gaussian filtering window size and a Gaussian filtering smoothness parameter for constructing a Gaussian filtering function; calculating first order partial derivatives of the Gaussian filtering function in different directions respectively; performing convolution operation on the first order partial derivatives in different directions with original images in corresponding directions and images to be registered in corresponding directions respectively, and obtaining filtered original images and filtered images to be registered in corresponding directions; and performing image registration on the filtered original images and the filtered images to be registered. denoising by filtering during image registration is implemented, and the image registration precision is improved.

### CROSS-REFERENCE TO RELATED APPLICATIONS

This application is a continuation of PCT international application No. PCT/CN2016/082536, filed May 18, 2016, which claims priority to Chinese Patent Application No. 201510786425.4, filed Nov. 16, 2015, the entire contents of which are incorporated herein by reference.

### TECHNICAL FIELD

This relates to the field of image processing, and more particularly, to an image preprocessing method and an image preprocessing device for image registration.

### BACKGROUND

Image registration (Image registration) refers to a process of matching and overlaying two or more images acquired by different sensors (imaging apparatuses) at different times or under different conditions (weather, intensity of illumination, camera position and angle, etc.), which has been widely applied to such fields as data analysis, image processing, remote sensing data analysis, image fusion, super-resolution reconstruction of images and medical image processing, or the like.

According to the method used, the image registration may be classified into two categories: region-based image registration and feature-based image registration. The theoretical basis of a registration method based on cross-power spectrum (phase correlation) is Fourier transform. Under the premise of the Fast Fourier Transform Algorithm FFT presenting in the field of Fourier transform, the registration method has such advantages like simple algorithm and fast speed, and is widely applied in image registration, pattern recognition, feature matching, or the like.

However, the image registration method based on cross-power spectrum mainly utilizes the changes of high-frequency components in the image, while the high-frequency components are easily influenced by noises, thus resulting in reduction of the image registration precision.

Therefore, it is highly desirable to propose an image preprocessing method for image registration.

### SUMMARY

Some embodiments of the present disclosure provide an image preprocessing method and an image processing device for image registration, so as to solve the defect that the image registration process is easily influenced by noises, and improve the image registration precision.

Some embodiments of the present disclosure provide an image preprocessing method for image registration, including:

selecting a Gaussian filtering window size and a Gaussian filtering smoothness parameter for constructing a Gaussian filtering function;

calculating first order partial derivatives of the Gaussian filtering function in different directions respectively;

performing convolution operation on the first order partial derivatives in different directions with original images in corresponding directions and images to be registered in corresponding directions respectively and obtaining filtered original images and filtered images to be registered in corresponding directions; and

performing image registration on the filtered original images and the filtered images to be registered.

Some embodiments of the present disclosure provide an image preprocessing electronic device for image registration, including:

at least one processor; and

a memory communicably connected with the at least one processor for storing instructions executable by the at least one processor, wherein execution of the instructions by the at least one processor causes the at least one processor to:

select a Gaussian filtering window size and a Gaussian filtering smoothness parameter for constructing a Gaussian filtering function;

calculate first order partial derivatives of the Gaussian filtering function in different directions respectively;

perform convolution operation on the first order partial derivatives in different directions with original images in corresponding directions and images to be registered in corresponding directions respectively, and obtain filtered original images and filtered images to be registered in corresponding directions; and

perform image registration on the filtered original images and the filtered images to be registered.

The image preprocessing method and image preprocessing device for image registration provided by some embodiments of the present disclosure use Gaussian kernel to perform convolution preprocessing on the images, i.e., perform filtering processing on the images, which can effectively eliminate the influences of noises presented parts of the image with minor content changes, emphasize the contributions of parts of the images with abundant details and larger content changes on image registration, and improve the image registration precision.

### BRIEF DESCRIPTION OF THE DRAWINGS

The drawings illustrated herein are intended to provide further understanding of the present disclosure, constituting a part of the present application. Exemplary embodiments and explanations of the present disclosure here are only for explanation of the present disclosure, but are not intended to limit the present disclosure. In the drawings:

FIG. 1 is a technical flow chart of a first embodiment of the present disclosure;

FIG. 2 is a technical flow chart of a second embodiment of the present disclosure;

FIG. 3 is a technical flow chart of a third embodiment of the present disclosure;

FIG. 4 is a structural diagram of a device of a fourth embodiment of the present disclosure; and

FIG. 5 is a block diagram of an electronic device in accordance with some embodiments.

### DETAILED DESCRIPTION

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

It should be illustrated that the various embodiments of the present disclosure do not exist alone, but are detailed elaboration of a technical solution in different application scenarios.

### First Embodiment

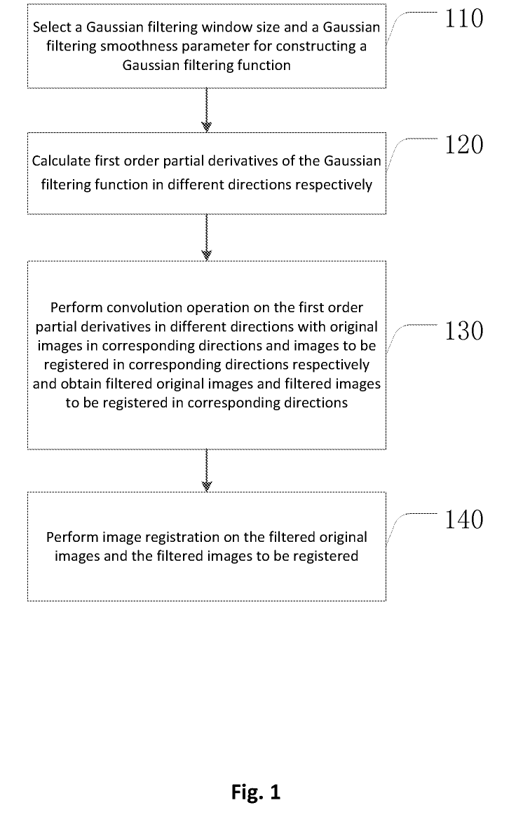

FIG. 1 is a technical flow chart of the first embodiment of the present disclosure. With reference to FIG. 1, an image preprocessing method for image registration of the present disclosure is mainly implemented through the following steps.

In step 110: a Gaussian filtering window size and a Gaussian filtering smoothness parameter are selected for constructing a Gaussian filtering function.

Generally speaking, image filtering includes spatial filtering and frequency domain filtering. It is called linear filtering (for example, the most common mean filtering and Gaussian filtering) if an output pixel is a linear combination of neighborhood pixels of an input pixel; otherwise, it is nonlinear filtering (median filtering, edge-preserving filtering, etc.). A linear smoothing filter has very good effects for removing Gaussian noises, and also has very good effects for other types of noises in most cases.

In the embodiment of the present disclosure, the original images and the images to be registered are not directly filtered through a Gaussian filter, but are filtered through the convolution of Gaussian derivative kernels; in this way, the change information of each direction in the image can be extracted more preferably while denoising. Partial differentials of the Gaussian function are utilized in the convolution of the Gaussian derivative kernels; therefore, the Gaussian function parameter also needs to be set in advance, i.e., the window size and the smoothness parameter of the Gaussian filter are selected.

The filtering of the Gaussian filter is a process of performing weighted average on the entire image, wherein the value of each pixel is obtained by the weighted average of the value of the pixel itself and values of other pixels in a window neighborhood. Selection of the window size is critical. If the window size is too small, then the denoising degree of the pixels is not enough, and the pixels are easily influenced by noises; if the window size is oversize, the calculation will be increased. The embodiment of the present disclosure selects a 7*7 window size usually, and this is an empirical value. Best filtering effects can be achieved usually by setting the window of the Gaussian filter as 7*7, but the window size is not limited in the embodiment of the present disclosure.

In step 120: first order partial derivatives of the Gaussian filtering function in different directions are calculated respectively.

In the embodiment of the present disclosure, the different directions are determined according to the dimensions of images processed. For example, a mathematical model corresponding to a two-dimensional Gaussian filter shall be selected to calculate partial derivatives for an ordinary two-dimensional plane image. The mathematical model of the two-dimensional Gaussian filter is as follows:

$$G ( x , y ) = {e}^{- \frac{{( x - {x}_{0} )}^{2} + {( y - {y}_{0} )}^{2}}{2 {σ}^{2}}}$$

Wherein, σ is a smoothness parameter, and the width of the Gaussian filter (determining the smoothness) is characterized by the smoothness parameter σ; moreover, the relationship between the smoothness parameter σ and the smoothness is very simple, the larger σ is, the wider the frequency band of the Gaussian filter is, and the better the smoothness is.

When the application scenario of the embodiment of the present disclosure is image registration of a two-dimensional image, first order partial derivatives of a two-dimensional Gaussian function in horizontal and vertical directions are calculated respectively:

$$Gx = \frac{\partial G ( x , y )}{\partial x} = - \frac{x - {x}_{0}}{σ} \cdot {e}^{- \frac{{( x - {x}_{0} )}^{2} + {( y - {y}_{0} )}^{2}}{2 {σ}^{2}}}$$

$$Gy = \frac{\partial G ( x , y )}{\partial y} = - \frac{y - {y}_{0}}{σ} \cdot {e}^{- \frac{{( x - {x}_{0} )}^{2} + {( y - {y}_{0} )}^{2}}{2 {σ}^{2}}}$$

Wherein, Gx is a first order partial derivative of a two-dimensional Gaussian function G(x, y) in horizontal direction (x direction), and Gy is a first order partial derivative of the two-dimensional Gaussian function G(x, y) in vertical direction (Y direction).

In step 130: convolution operation is performed on the first order partial derivatives in different directions with original images in corresponding directions and images to be registered in corresponding directions respectively, filtered original images and filtered images to be registered in corresponding directions are obtained.

The filtering result of the convolution of Gaussian derivative kernels is presented in a gradient image, and the gradient image of the convolution of the two-dimensional Gaussian derivative kernels is as shown below:

I_Gx(x,y)=I(x,y) [symbol] Gx

I_Gy(x,y)=I(x,y) [symbol] Gy

Wherein, [symbol] represents convolution operation, I(x, y) is a function corresponding to the images to be filtered, I_Gx(x, y) is a filtered gradient image in horizontal direction, and I_Gy(x,y) is a filtered gradient image in vertical direction.

In the embodiment of the present disclosure, it is provided that the original image is f(x,y), and the image to be registered is g(x,y), then the gradient images in horizontal direction and vertical direction corresponding to the filtered original image are respectively:

fh_Gx(x,y)=f(x,y) [symbol] Gx

fv_Gy(x,y)=f(x,y) [symbol] Gy

The gradient images in horizontal direction and vertical direction corresponding to the filtered image to be registered are respectively:

gh_Gx(x,y)=g(x,y) [symbol] Gx

gv_Gy(x,y)=g(x,y) [symbol] Gy

In step 140: image registration is performed on the filtered original images and the filtered images to be registered.

Preferably, the image preprocessing method of the embodiment of the present disclosure is applied to a registration method based on cross-power spectrum. The registration method based on cross-power spectrum (phase correlation), which is one of region-based image registration methods, implements quick registration of images by detection through translation, rotation and zooming between two images. The image registration method based on cross-power spectrum mainly utilizes the changes of high-frequency components after image transformation, and usually performs registration calculation on the two images directly, which not only includes low-frequency components, but also includes high-frequency components. However, the registration precision will be reduced since the high-frequency components are easily influenced by noises.

A displacement theory ensures the equivalence of the cross-power spectrum phase and the phase difference of the two images; therefore, a pulse function δ (x−x0, y−y0) may be obtained by performing Fourier inverse transform on the cross-power spectrum. Because the pulse function has apparent sharp peak values at a displacement position (x0, y0), and the values of other positions are close to zero, the offset between the two images can be acquired hereby.

The image registration principle based on cross-power spectrum is as follows:

Let r(x, y) to be a two-two-dimensional image, and the Fourier transform thereof is R(u, v), and a(x₀,y₀) displacement occurs to an image p(x, y) relative to the image r(x, y):

p(x,y)=r(x−x₀,y−y₀)

The Fourier transform of p(x, y) is:

P(u,v)=e^{-2π(ux}^{₀}^{+vy}^{₀}⁾R(u,v)

Therefore, the normalized cross-power spectrum thereof can be represented as:

$$\frac{R ( u , v ) {P}^{*} ( u , v )}{R \vert F ( u , v ) {P}^{*} ( u , v ) \vert} = {e}^{i2π ( {ux}_{0} + {vy}_{0} )}$$

Wherein, P*(u,v) represents the conjugation of P(u,v).

R⁻¹{e^{i2π(ux}^{₀}^{+vy}^{₀}⁾}=δ(x−x₀,y−y₀)

Wherein, R⁻¹ { } represents Fourier inverse transform.

The pulse function δ (x−x0, y−y0) has apparent sharp peak values at a displacement position (x0, y0), and the values of other positions are close to zero; therefore, the offset between the two images can be acquired hereby.

In the embodiment of the present disclosure, horizontal registration and vertical registration are performed on the filtered original images and filtered images to be registered respectively according to the foregoing principle, i.e., registration is performed on fh_Gx(x, y) and gh_Gx(x, y), and then registration is performed on gh_Gx(x, y) and gv_Gy(x,y). Certainly, the foregoing registration sequences are for illustration only, and there is no order of priority for the registration in horizontal direction and the registration in vertical direction actually. The image registration will not be elaborated herein since it is very mature in the prior art.

In the embodiment, the images are filtering preprocessed through Gaussian kernel convolution, which can effectively eliminate the influences of noises presented parts of the image with minor content changes, emphasize the contributions of parts of the images with abundant details and larger content changes on image registration, and enhance the effects of the high-frequency components, thus improving the image registration precision.

### Second Embodiment

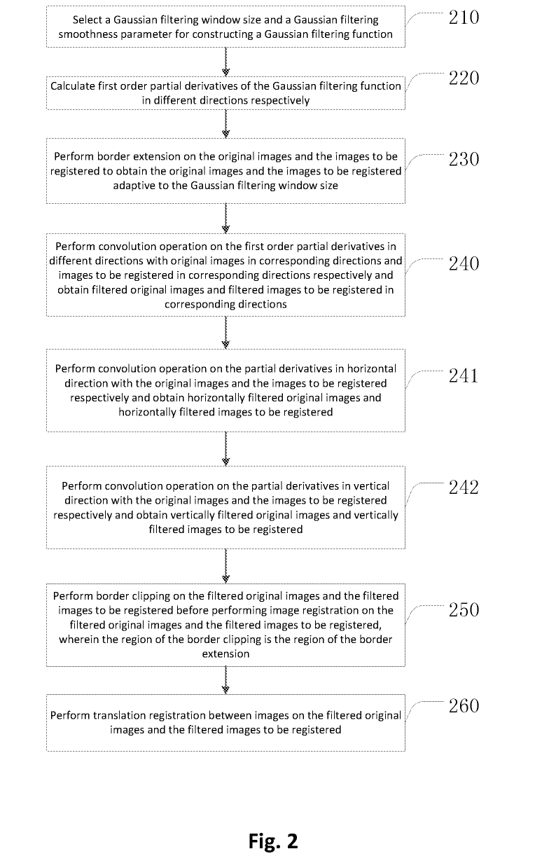

FIG. 2 is a technical flow chart of the second embodiment of the present disclosure. A step of implementing translation registration among images in an image preprocessing method for image registration of the embodiment of the present disclosure will be explained hereinafter with reference to FIG. 2 and one more detailed embodiment.

In step 210: a Gaussian filtering window size and a Gaussian filtering smoothness parameter are selected for constructing a Gaussian filtering function.

In step 220: first order partial derivatives of the Gaussian filtering function in different directions are calculated respectively.

In step 230: border extension is performed on the original images and the images to be registered to obtain the original images and the images to be registered adaptive to the Gaussian filtering window size.

Because a filtering method based on a Gaussian function employs a weighted average algorithm on the values of the pixels in a window neighborhood for each pixel during filtering processing, performing border extension on the image facilitates processing the pixels at the edge of the image. For example, the border of the original image needs to be extended outwards by at least two pixels for Gaussian filtering with a 3*3 window, and a weighted average manner on the pixels in a neighborhood can be used on the pixels at the edge of the original image for denoising.

Image border extension methods used in the embodiment of the present disclosure may be zero padding, periodic padding, mirror image padding or padding by copying the values of outer borders.

Preferably, a mirror image padding method is employed in the embodiment of the present disclosure to perform border extension on the original images, and the extension size is determined according to a filtering window size selected.

Optionally, the embodiment of the present disclosure may also implement the border extension of the images directly with the help of OpenCV. OpenCV provides several different border extension strategies:
BORDER_REPLICATE: aaaaaa|abcdefgh|hhhhhhh
BORDER_REFLECT: fedcba|abcdefgh|hgfedcb
BORDER_REFLECT 101: gfedcb|abcdefgh|gfedcba
BORDER_WRAP: cdefgh|abcdefgh|abcdefg
BORDER_CONSTANT: iiiiii|abcdefgh|iiiiiii with some specified ‘i’

Where, “|” represents the border of the image, the contents of the image are between two “|”, and an i value needs to be additionally given for the last border extension strategy, for performing value assignment on an extra border.

A function copyMakeBorder( ) provided by OpenCV is employed to extend the border, wherein the prototype thereof is as follows:

void copyMakeBorder(InputArraysrc, OutputArraydst, int top, int bottom, int left, int right, intborderType, const Scalar& value=Scalar( )) wherein, src is an input array; dst is an output array after border extension; top is the number of lines extended upward from the top border of src; bottom is the number of lines extended downward from the bottom border of src; left is the number of rows extended to the left from the left border of src; right is the number of rows extended to the right from the right border of src; borderType is one of the border extension strategies; and value is a constant value filled in at the border when BORDER_CONSTANT is used as the border extension strategy.

It should be illustrated that there is no order of priority for step 220 and step 230. In the embodiment of the present disclosure, the images may be extended firstly, and then the first order partial derivatives of the Gaussian filtering function in different directions are calculated.

In step 240: convolution operation is performed on the first order partial derivatives in different directions with original images in corresponding directions and images to be registered in corresponding directions respectively, and obtain filtered original images and filtered images to be registered in corresponding directions.

Specifically, step 240 further includes step 241 and step 242.

In step 241: convolution operation is performed on the partial derivatives in horizontal direction with the original images and the images to be registered respectively and obtain horizontally filtered original images and horizontally filtered images to be registered.

In step 242: convolution operation is performed on the partial derivatives in vertical direction with the original images and the images to be registered respectively and obtain vertically filtered original images and vertically filtered images to be registered.

In step 250: border clipping is performed on the filtered original images and the filtered images to be registered, wherein the region of the border clipping is the region of the border extension.

In the embodiment of the present disclosure, border extension is both performed on the original images and the images to be registered so as to obtain an image size matched with the Gaussian filtering window, wherein the main object is to facilitate processing the original pixels at the edge of the image during filtering, but this extended part is not needed in actual registration. Therefore, the embodiment of the present disclosure preferably needs to clip this region that does not belong to the original image after completing filtering processing so as to ensure the registration effects.

In step 260: translation registration between images is performed on the filtered original images and the filtered images to be registered.

In the embodiment, the object of performing border extension on the original images and the images to be processed is to obtain preferable filtering effects; and exact translation registration between images is implemented by filtering the original images and images to be processed.

### Third Embodiment

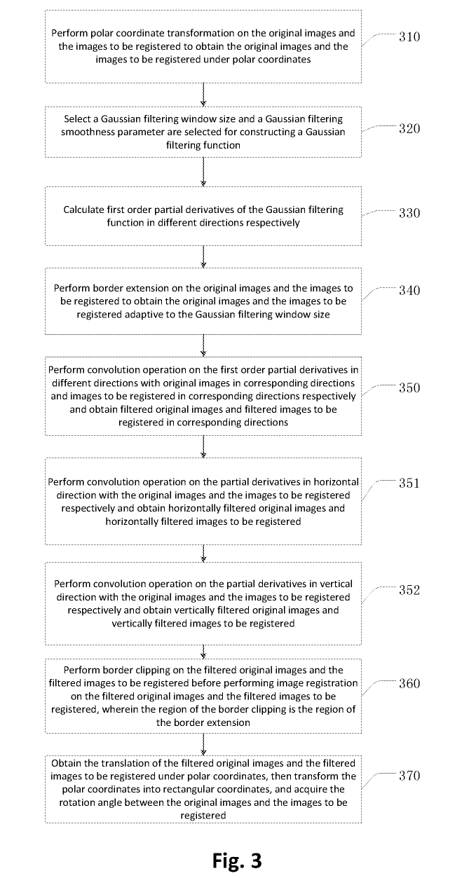

FIG. 3 is a technical flow chart of the third embodiment of the present disclosure. A step of implementing registration of a rotation angle between images in an image preprocessing method for image registration of the embodiment of the present disclosure will be explained hereinafter with reference to FIG. 3 and one more detailed embodiment.

In step 310: polar coordinate transformation is performed on the original images and the images to be registered, and obtain the original images and the images to be registered under polar coordinates.

When performing registration of a rotation angle between images, the size of the rotation angle between the original images and the images to be registered needs to be acquired firstly. A method employed in the embodiment of the present disclosure is to perform polar coordinate transformation on the original images and the images to be registered firstly to acquire translation of the original images and the images to be registered under the polar coordinates, and then transform the translation under the polar coordinates into the angle of the rotation angle under a rectangular plane coordinate system.

In step 320: a Gaussian filtering window size and a Gaussian filtering smoothness parameter are selected for constructing a Gaussian filtering function.

In step 330: first order partial derivatives of the Gaussian filtering function in different directions are calculated respectively.

In step 340: border extension is performed on the original images and the images to be registered to obtain the original images and the images to be registered adaptive to the Gaussian filtering window size.

It should be illustrated that there is no order of priority for step 330 and step 340. In the embodiment of the present disclosure, the images may be extended firstly, and then the first order partial derivatives of the Gaussian filtering function in different directions are calculated.

In step 350: convolution operation is performed on the first order partial derivatives in different directions with original images in corresponding directions and images to be registered in corresponding directions respectively, and obtain filtered original images and filtered images to be registered in corresponding directions.

Specifically, step 340 further includes step 341 and step 342.

In step 351: convolution operation is performed on the partial derivatives in horizontal direction with the original images and the images to be registered respectively and obtain horizontally filtered original images and horizontally filtered images to be registered.

In step 352: convolution operation is performed on the partial derivatives in vertical direction with the original images and the images to be registered respectively and obtain vertically filtered original images and vertically filtered images to be registered.

In step 360: border clipping is performed on the filtered original images and the filtered images to be registered, wherein the region of the border clipping is the region of the border extension.

In step 370: the translation of the filtered original images and the filtered images to be registered under polar coordinates is acquired, then the polar coordinates are transformed into rectangular coordinates, and the rotation angle between the original images and the images to be registered is acquired.

Preferably, when performing registration on the rotation angles between images, the embodiment of the present disclosure employs image registration based on Fourier-Mellin Transform, wherein the principle thereof is described as follows:

it is provided that an image f2(x, y) is the result of an image f1(x, y) after translating (x₀, y₀) and rotating a θ₀ angle, i.e.:

f₂(x,y)=f₁(x cos θ₀+y sin θ₀−x₀−x₀,sin θ₀+y cos θ₀−y₀)

the relationship between the two after Fourier transform is:

F₂(ε,η)=e^{-j2π(εx}^{₀}^{+ny}^{₀}⁾×F₁(ε cos θ₀η sin θ₀,−ε sin θ₀+η cos θ₀)

the relationship of the amplitudes M1 and M2 thereof is:

M₂(ε,η)=M₁(ε cos θ₀+η sin θ₀,−ε sin θ₀+η cos θ₀)

Under a system of polar coordinates, the relationship between the two is:

M₂(ρ,θ)=M₁(ρ,θ−θ₀)

The translation of angles in axial direction in the system of polar coordinates is obtained through calculating the cross-power spectrum of the two, and the polar coordinates are transformed into rectangular coordinates, thus being capable of acquiring the rotation angle thereof.

In the embodiment, the translation of the original images and the images to be registered under the polar coordinates is acquired by transforming the images in plane coordinates into the images in the polar coordinates and then filtering the images in the polar coordinates for denoising; then the value of the rotation angle between the denoised original images and the denoised images to be registered is obtained by transforming the polar coordinates into rectangular coordinates, thus improving the registration precision of the rotation angles of the image.

### Fourth Embodiment

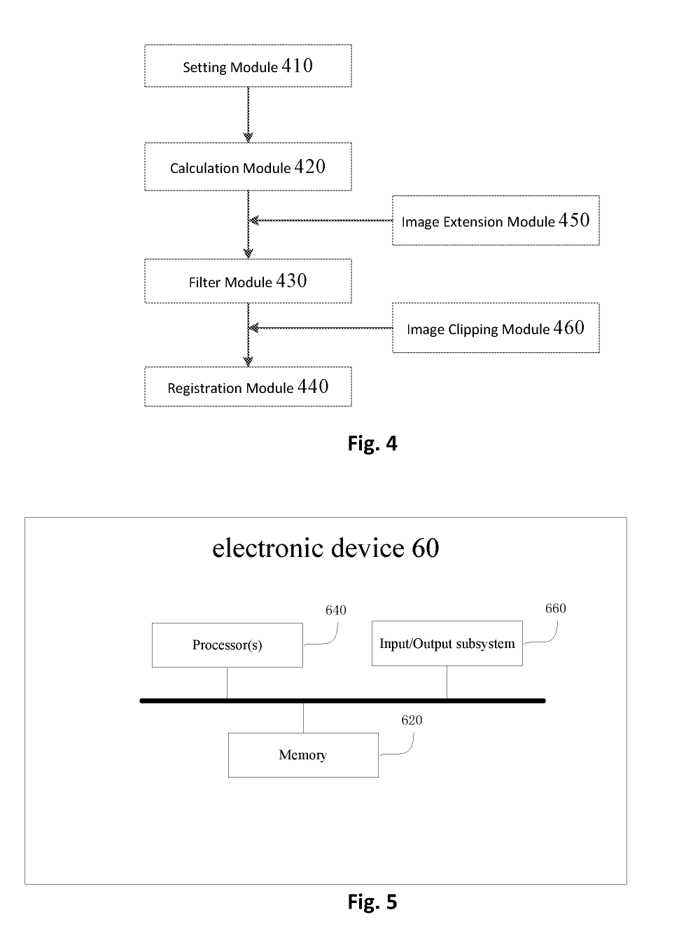

FIG. 4 is a structural diagram of a device of the fourth embodiment of the present disclosure. With reference to FIG. 4, an image preprocessing device for image registration according to the embodiment of the present disclosure mainly includes the following modules: a setting module 410, a calculation module 420, a filter module 430 and a registration module 440.

The setting module 410 is configured to select a Gaussian filtering window size and a Gaussian filtering smoothness parameter for constructing a Gaussian filtering function.

The calculation module 420 is connected with the setting module 410, and configured to calculate first order partial derivatives in different directions of the Gaussian filtering function respectively according to the parameter set by the setting module 410.

The filter module 430 is connected with the calculation module 420, and configured to perform convolution operation on the first order partial derivatives in different directions with original images in corresponding directions and images to be registered in corresponding directions respectively, and obtain filtered original images and filtered images to be registered in corresponding directions.

The registration module 440 is configured to perform image registration on the filtered original images and the filtered images to be registered.

The device further includes an image extension module 450, wherein the image extension module 450 is configured to, before performing convolution operation on the first order partial derivatives in different directions with the original images in corresponding directions and the images to be registered in corresponding directions respectively, perform border extension on the original images and the images to be registered and obtain the original images and the images to be registered adaptive to the Gaussian filtering window size.

Further, the filter module 430 is configured to perform convolution operation on the partial derivatives in horizontal direction with the original images and the images to be registered respectively and obtain horizontally filtered original images and horizontally filtered images to be registered; and perform convolution operation on the partial derivatives in vertical direction with the original images and the images to be registered respectively and obtain vertically filtered original images and vertically filtered images to be registered.

The device further includes an image clipping module 460, wherein the image clipping module 460 is configured to:

perform border clipping on the filtered original images and the filtered images to be registered before performing image registration on the filtered original images and the filtered images to be registered, wherein the region of the border clipping is the region of the border extension.

The device further includes a coordinate transformation module 470, wherein the coordinate transformation module 470 is configured to, when performing registration on the rotation angle of the image, perform polar coordinate transformation on the original images and the images to be registered in advance before performing the convolution operation, and obtain the original images and the images to be registered under polar coordinates.

Attention is now directed toward embodiments of an electronic device. FIG. 5 is a block diagram illustrating an electronic device 60. The electronic device may include memory 620 (which may include one or more computer readable storage mediums), at least one processor 640, and input/output subsystem 660. These components may communicate over one or more communication buses or signal lines. It should be appreciated that the electronic device 60 may have more or fewer components than shown, may combine two or more components, or may have a different configuration or arrangement of the components. The various components may be implemented in hardware, software, or a combination of both hardware and software.

The memory 620, as a non-volatile computer readable storage medium, may be configured to store non-volatile software programs, non-volatile computer executable programs and modules, for example, the program instructions/modules corresponding to the image preprocessing method for image registration in some embodiments of the present application. The non-volatile software programs, instructions and modules stored in the memory 620, when being executed, cause the processor 610 to perform various function applications and data processing, that is, performing the image preprocessing method for image registration in the above method embodiments.

The memory 620 may also include a program storage area and a data storage area. The program storage area may store an operating system and an application implementing at least one function. The data storage area may store data created according to use of the image preprocessing device for image registration. In addition, the memory 620 may include a high speed random access memory, or include a non-volatile memory, for example, at least one disk storage device, a flash memory device, or another non-volatile solid storage device. In some embodiments, the memory 620 optionally includes memories remotely configured relative to the at least one processor 610. These memories may be connected to the image preprocessing device for image registration over a network. The above examples include, but not limited to, the Internet, Intranet, local area network, mobile communication network and a combination thereof.

One or more modules are stored in the memory 620, and when being executed by the one or more processors 610, perform the image preprocessing method for image registration in any of the above method embodiments.

The product may perform the method according to some embodiments of the present application, has corresponding function modules for performing the method, and achieves the corresponding beneficial effects. For technical details that are not illustrated in detail in this embodiment, reference may be made to the description of the methods according to some embodiments of the present application.

Moreover, executable instructions for performing various functions may be included in a non-transitory computer readable storage medium or other computer program product configured for execution by at least one processor. Some embodiments of the present invention also provides a non-transitory computer-readable storage medium storing executable instructions that, when executed by an electronic device with a touch-sensitive display, cause the electronic device to perform the method as shown in FIG. 1, FIG. 2 or FIG. 3.

The electronic device in some embodiments of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone or the like;
(2) an ultra mobile personal computer device: which pertains to the category of personal computers and has the computing and processing functions, and additionally has the mobile Internet access feature; such terminals include: a PDA, an MID, an UIVIPC device or the like, for example, an iPad;
(3) a portable entertainment device: which displays and plays multimedia content; such devices include: an audio or video player (for example, an iPod), a palm game machine, an electronic book, and a smart toy, and a portable vehicle-mounted navigation device;
(4) a server: which provides services for computers, and includes a processor, a hard disk, a memory, a system bus or the like; the server is similar to the general computer in terms of architecture; however, since more reliable services need to be provided, higher requirements are imposed on the processing capability, stability, reliability, security, extensibility, manageability or the like of the device; and
(5) another electronic device having the data interaction function. The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer apparatus (which may be a personal computer, a server, or a network apparatus so on) to perform the method according to each embodiment or some parts of some embodiments.

The explanation above shows and describes some embodiments of the disclosure, but as previously mentioned, it should be understood that the present application is not limited to the forms disclosed herein, and shall not be deemed as an exclusion to other embodiments, but can be applied to various other combinations, amendments and circumstances, and can be modified through the foregoing teaching or technologies or knowledge of related arts within the scope of the disclosure concept herein. While modifications and changes made by those skilled in the art without departing from the spirit and scope of the present application shall all fall within the protection scope of the claims of the present application appended.

What is claimed is:

1. An image preprocessing method for image registration, at an electronic device, comprising:
selecting a Gaussian filtering window size and a Gaussian filtering smoothness parameter for constructing a Gaussian filtering function;
calculating first order partial derivatives of the Gaussian filtering function in different directions respectively;
performing convolution operation on the first order partial derivatives in different directions with original images in corresponding directions and images to be registered in corresponding directions respectively, and obtaining filtered original images and filtered images to be registered in corresponding directions; and
performing image registration on the filtered original images and the filtered images to be registered.

2. The method according to claim 1, wherein the method, before the performing convolution operation on the first order partial derivatives in different directions with the original images in corresponding directions and the images to be registered in corresponding directions respectively, further comprising:
performing border extension on the original images and the images to be registered to obtain the original images and the images to be registered adaptive to the Gaussian filtering window size.

3. The method according to claim 1, wherein the performing convolution operation on the first order partial derivatives in different directions with the original images in corresponding directions and the images to be registered in corresponding directions respectively further comprises:
performing convolution operation on the partial derivatives in horizontal direction with the original images and the images to be registered respectively and obtaining horizontally filtered original images and horizontally filtered images to be registered; and
performing convolution operation on the partial derivatives in vertical direction with the original images and the images to be registered respectively and obtaining vertically filtered original images and vertically filtered images to be registered.

4. The method according to claim 1, further comprising:
performing border clipping on the filtered original images and the filtered images to be registered before performing image registration on the filtered original images and the filtered images to be registered, wherein the region of the border clipping is the region of the border extension.

5. The method according to claim 1, further comprising:
when performing registration on the rotation angle of the image, performing polar coordinate transformation on the original images and the images to be registered in advance before performing the convolution operation, and obtaining the original images and the images to be registered under polar coordinates.

6. An image preprocessing electronic device for image registration, comprising:
at least one processor; and
a memory communicably connected with the at least one processor for storing instructions executable by the at least one processor, wherein execution of the instructions by the at least one processor causes the at least one processor to:
select a Gaussian filtering window size and a Gaussian filtering smoothness parameter for constructing a Gaussian filtering function;
calculate first order partial derivatives of the Gaussian filtering function in different directions respectively;
perform convolution operation on the first order partial derivatives in different directions with original images in corresponding directions and images to be registered in corresponding directions respectively, and obtain filtered original images and filtered images to be registered in corresponding directions; and
perform image registration on the filtered original images and the filtered images to be registered.

7. The electronic device according to claim 6, wherein the at least one processor is further caused to:
before the performing convolution operation on the first order partial derivatives in different directions with the original images in corresponding directions and the images to be registered in corresponding directions respectively, perform border extension on the original images and the images to be registered to obtain the original images and the images to be registered adaptive to the Gaussian filtering window size.

8. The electronic device according to claim 6, wherein the step to perform convolution operation on the first order partial derivatives in different directions with the original images in corresponding directions and the images to be registered in corresponding directions respectively further comprises:
perform convolution operation on the partial derivatives in horizontal direction with the original images and the images to be registered respectively and obtain horizontally filtered original images and horizontally filtered images to be registered; and
perform convolution operation on the partial derivatives in vertical direction with the original images and the images to be registered respectively and obtain vertically filtered original images and vertically filtered images to be registered.

9. The electronic device according to claim 6, wherein the at least one processor is further caused to:
perform border clipping on the filtered original images and the filtered images to be registered before performing image registration on the filtered original images and the filtered images to be registered, wherein the region of the border clipping is the region of the border extension.

10. The electronic device according to claim 6, wherein the at least one processor is further caused to:
when performing registration on the rotation angle of the image, perform polar coordinate transformation on the original images and the images to be registered in advance before performing the convolution operation, and obtain the original images and the images to be registered under polar coordinates.

11. A non-transitory computer-readable storage medium storing executable instructions that, when executed by an electronic device with a touch-sensitive display, cause the electronic device tom:
select a Gaussian filtering window size and a Gaussian filtering smoothness parameter for constructing a Gaussian filtering function;
calculate first order partial derivatives of the Gaussian filtering function in different directions respectively;
perform convolution operation on the first order partial derivatives in different directions with original images in corresponding directions and images to be registered in corresponding directions respectively, and obtain filtered original images and filtered images to be registered in corresponding directions; and
perform image registration on the filtered original images and the filtered images to be registered.

12. The non-transitory computer-readable storage medium according to claim 11, wherein the electronic device is further caused to:
before the performing convolution operation on the first order partial derivatives in different directions with the original images in corresponding directions and the images to be registered in corresponding directions respectively, perform border extension on the original images and the images to be registered to obtain the original images and the images to be registered adaptive to the Gaussian filtering window size.

13. The non-transitory computer-readable storage medium according to claim 11, wherein the step to perform convolution operation on the first order partial derivatives in different directions with the original images in corresponding directions and the images to be registered in corresponding directions respectively further comprises:
perform convolution operation on the partial derivatives in horizontal direction with the original images and the images to be registered respectively and obtain horizontally filtered original images and horizontally filtered images to be registered; and
perform convolution operation on the partial derivatives in vertical direction with the original images and the images to be registered respectively and obtain vertically filtered original images and vertically filtered images to be registered.

14. The non-transitory computer-readable storage medium according to claim 11, wherein the electronic device is further caused to:
perform border clipping on the filtered original images and the filtered images to be registered before performing image registration on the filtered original images and the filtered images to be registered, wherein the region of the border clipping is the region of the border extension.

15. The non-transitory computer-readable storage medium according to claim 11, wherein the electronic device is further caused to:
when performing registration on the rotation angle of the image, perform polar coordinate transformation on the original images and the images to be registered in advance before performing the convolution operation, and obtain the original images and the images to be registered under polar coordinates.
